(19) United States
(12) Patent Application Publication
(10) Pub. No.: US 2024/0191792 A1
(43) Pub. Date: Jun. 13, 2024

(54) GEAR RACK

(71) Applicant: TOYOTA BOSHOKU SEIKO CORPORATION, Takahama-shi (JP)

(72) Inventors: Masaki OKADA, Takahama-shi (JP); Takayuki OGASAWARA, Takahama-shi (JP); Hiroaki HYODO, Takahama-shi (JP)

(73) Assignee: TOYOTA BOSHOKU SEIKO CORPORATION, Takahama-shi (JP)

(21) Appl. No.: 18/524,114

(22) Filed: Nov. 30, 2023

(30) Foreign Application Priority Data
Dec. 12, 2022 (JP) 2022-197883

(51) Int. Cl. F16H 55/26; F16H 19/04

(52) U.S. Cl. CPC F16H 55/26; F16H 19/04; B60N 2/06

(57) ABSTRACT

A pinion gear approaching to a gear rack will engages end tooth located at the end of a row of teeth of the gear rack. The pinion gear may not engage with the end tooth smoothly. The disclosure herein provides a gear rack that allows a pinion gear to smoothly shift from a disengaged state where the pinion gear is disengaged from the gear rack to an engaged state. In a gear rack, a size of the end tooth may be smaller than a size of normal teeth located closer to a center of the row of teeth than the end tooth. A smaller end tooth allow the pinion gear to engage the gear rack smoothly.

### REFERENCE TO RELATED APPLICATION

This application claims priority to Japanese Patent Application No. 2022-197883 filed on Dec. 12, 2022, the contents of which are hereby incorporated by reference into the present application.

### BACKGROUND ART

The disclosure herein relates to a gear rack.

A rack-and-pinion including a gear rack and a pinion gear is used in a variety of devices. For example, Japanese Patent Application Publication No. 2018-193007 describes an example in which a rack-and-pinion is applied to a seat slider device that slides a seat of a vehicle. The seat slider device includes a lower rail attached to the floor of a vehicle body and an upper rail fixed to the seat. The upper rail slidably engages the lower rail. The lower rail includes a gear rack, and the upper rail includes a pinion gear and a motor configured to rotate the pinion gear. The gear rack is fixed to a bottom surface of the lower rail. The pinion gear engages the gear rack. The upper rail including the pinion gear is moved along the gear rack by the motor driving the pinion gear. That is, the seat is moved in a longitudinal direction of the lower rail.

### DESCRIPTION

There may be a demand that a seat can be slid in an electrically powered manner within part of a seat's range of movement and a user can freely move the seat in the rest of the range of movement. To meet such a demand, a gear rack is provided in a partial section of the overall length of the lower rail. A pinion gear of an upper rail engages the gear rack in a certain section (engagement section), while the pinion gear is free of the engagement with the gear rack in another section (free section). In the engagement section, the upper rail (i.e., the seat) is moved relative to the lower rail when the motor drives the pinion gear. In the engagement section, the seat cannot be moved by human power. In the free section, the upper rail (i.e., the seat) can be freely moved by human power since the pinion gear does not engage the gear rack. In this case, however, the free pinion gear may not properly engage an end tooth of the gear rack when moving from the free section to the engagement section. The disclosure herein provides a gear rack that allows a pinion gear to smoothly shift from a disengaged state where the pinion gear is disengaged from the gear rack to an engaged state.

In a gear rack disclosed herein, a size of a tooth located at an end of a row of teeth on the gear rack may be smaller than a size of teeth located closer to a center of the row of teeth than the tooth. For explanatory convenience, the tooth located at the end of the row of teeth on the gear rack is referred to as an end tooth, and teeth located closer to the center of the row of teeth than the end tooth (and an adjacent tooth) are referred to as normal teeth. Further, a tooth located adjacent to the end tooth is referred to as an adjacent tooth. Since the size of the end tooth of the gear rack is smaller, a space between the end tooth and a pinion gear is larger than a space between the normal teeth and the pinion gear. Thus, the pinion gear can smoothly shift from a disengaged state where the pinion gear is disengaged from the gear rack to an engaged state.

A size of an adjacent tooth located adjacent to the end tooth may be larger than the size of the end tooth and smaller than the size of the normal teeth. The gradually increasing sizes of the end tooth, the adjacent tooth, and the normal teeth allow the pinion gear to smoothly engage the gear rack while moving from the end tooth to the normal teeth.

An aspect of the end tooth being smaller than the normal teeth is as follows. A height of the end tooth is lower than a height of the normal teeth, and the height of the end tooth is greater than a distance between a bottom of the normal teeth and a tip of a tooth of a pinion gear when the pinion gear engages the gear rack. The latter condition is required for the pinion gear to engage the end tooth. A height of the adjacent tooth may be higher than the height of the end tooth and lower than the height of the normal teeth.

Another aspect of the end tooth being smaller than the normal teeth is as follows. In a longitudinal direction of the gear rack, a tip width of the end tooth may be narrower than a tip width of the normal teeth. A tip width of the adjacent tooth may be wider than the tip width of the end tooth and narrower than the tip width of the normal teeth.

Yet another aspect of the end tooth being smaller than the normal teeth is as follows. An inclination angle of a side surface of the end tooth that is located closer to an end of the gear rack may be smaller than an inclination angle of side surfaces of the normal teeth. An inclination angle of a side surface of the adjacent tooth that is located closer to the end of the gear rack may be larger than the inclination angle of the side surface of the end tooth and smaller than the inclination angle of the side surfaces of the normal teeth. Here, “an inclination angle of side surface(s) of tooth(teeth)” means an inclination angle of the side surface relative to the longitudinal direction of the gear rack. In either aspect, a space between the end tooth and the pinion gear created when they engage is larger than a space between the normal teeth and the pinion gear created when they engage. The pinion gear can thus smoothly engage the gear rack when reaching the end tooth of the gear rack.

Details of the technique disclosed herein and further developments will be described in “EMBODIMENT”.

### BRIEF DESCRIPTION OF DRAWINGS

FIG. 1 is a side view of a gear rack according to an embodiment and a pinion gear before it engages the gear rack.

FIG. 2 is an enlarged side view of an end tooth of the gear rack and the pinion gear.

FIG. 3 is a side view of a gear rack according to a first variant.

FIG. 4 is a side view of a gear rack according to a second variant.

FIG. 5 is a side view of a gear rack according to a third variant.

FIG. 6 is a side view of a gear rack according to a fourth variant.

FIG. 7 is a side view of a gear rack according to a fifth variant.

FIG. 8 is a side view of a seat including a linear actuator (a seat slider device) according to an embodiment.

FIG. 9 is a front view of the seat slider device.

FIG. 10 is a side view of the seat slider device.

FIG. 11 is a diagram (1) illustrating how a gear rack and two pinion gears engage each other.

FIG. 12 is a diagram (2) illustrating how the gear rack and the two pinion gears engage each other.

FIG. 13 is a diagram (3) illustrating how the gear rack and the two pinion gears engage each other.

FIG. 14 is a diagram (4) illustrating how the gear rack and the two pinion gears engage each other.

FIG. 15 is a diagram illustrating a variant of the seat slider device.

### EMBODIMENT

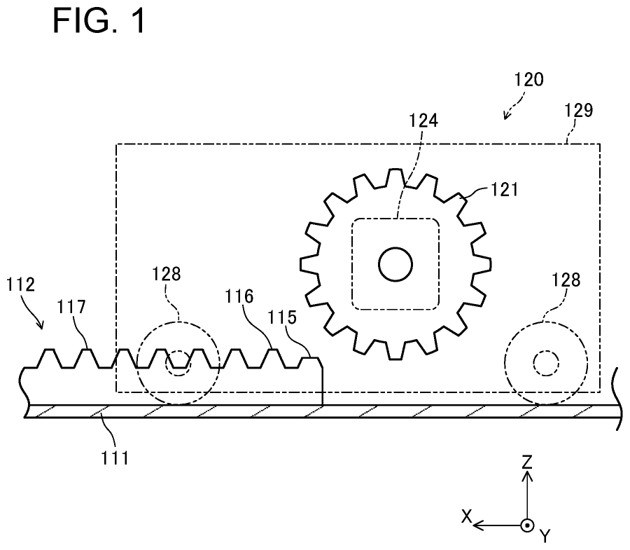

Referring to the drawings, a gear rack according to an embodiment is described. FIG. 1 shows a side view of a gear rack 112 according to an embodiment and a pinion gear 121 before it engages the gear rack 112.

The gear rack 112 is fixed to a floor panel 111. An X direction in the directional indicator in the drawing corresponds to a longitudinal direction of the gear rack 112. The “longitudinal direction of the gear rack 112 (X direction)” will be hereinafter referred to simply as a longitudinal direction. A Y direction in the directional indicator in the drawing corresponds to a short direction of the gear rack 112. The “short direction of the gear rack 112” will be hereinafter referred to simply as a short direction. A+Z direction in the directional indicator in the drawing indicates an upward direction. The same applies to the other drawings.

For explanatory convenience, a tooth located at an end of a row of teeth of the gear rack 112 is referred to an end tooth 115, a tooth adjacent to the end tooth 115 is referred to as an adjacent tooth 116, and the teeth other than the end tooth 115 and the adjacent tooth 116 are referred to as normal teeth 117. The teeth located closer to the center of the row of teeth of the gear rack 112 than the end tooth 115 and the adjacent tooth 116 are all normal teeth 117. In FIG. 1, only one normal tooth is labeled with a reference sign 117 and the labeling is omitted for the other normal teeth. In the example of FIG. 1, all the teeth but the end tooth 115 have the same shape as that of the normal teeth 117. The adjacent tooth 116 also has the same shape as that of the normal teeth 117. Only the end tooth 115 is smaller than the normal teeth 117.

The pinion gear 121 configured to engage the gear rack 112 is attached to a pinion unit 120. A body 129 of the pinion unit 120 includes rollers 128. In FIG. 1, the body 129 and the rollers 128 are depicted by imaginary lines. The rollers 128 are in contact with the floor panel 111 and the pinion unit 120 can move in the longitudinal direction relative to the floor panel 111. That is, the pinion unit 120 is restrained to the floor so as to be movable in the longitudinal direction but immovable in the other directions. The pinion gear 121 is attached to this pinion unit 120. The pinion unit 120 (the pinion gear 121) can move at positions spaced apart from the gear rack 112 in the longitudinal direction and also can move while engaging the gear rack 112.

When the pinion gear 121 is apart from the gear rack 112, the pinion unit 120 (the pinion gear 121) is in a free section. When the pinion gear 121 is in engagement with the gear rack 112, the pinion unit 120 (the pinion gar 121) is in an engagement section.

The pinion unit 120 includes a motor 124, and the pinion gear 121 is driven by the motor 124. In FIG. 1, the motor 124 is also depicted by an imaginary line.

FIG. 1 shows a state where the pinon unit 120 (the pinion gear 121) is in the free section. In this state, a user can move the pinion unit 120. As a result of the user moving the pinion unit 120 closer to the gear rack 112, the pinion gear 121 reaches the end tooth 115 of the gear rack 112. If the end tooth 115 has the same shape (size) as that of the normal teeth 117, it may be difficult for the rotating pinion gear 121 to engage the end tooth 115. For example, a tooth of the pinion gear 121 may run on the end tooth 115 and the pinion unit 120 including the pinion gear 121 may lift off the floor panel 111.

However, since the size of the end tooth 115 of the gear rack 112 according to the embodiment is smaller than that of the normal teeth 117, the pinion gear 121 can easily engage the end tooth 115 when reaching the gear rack 112.

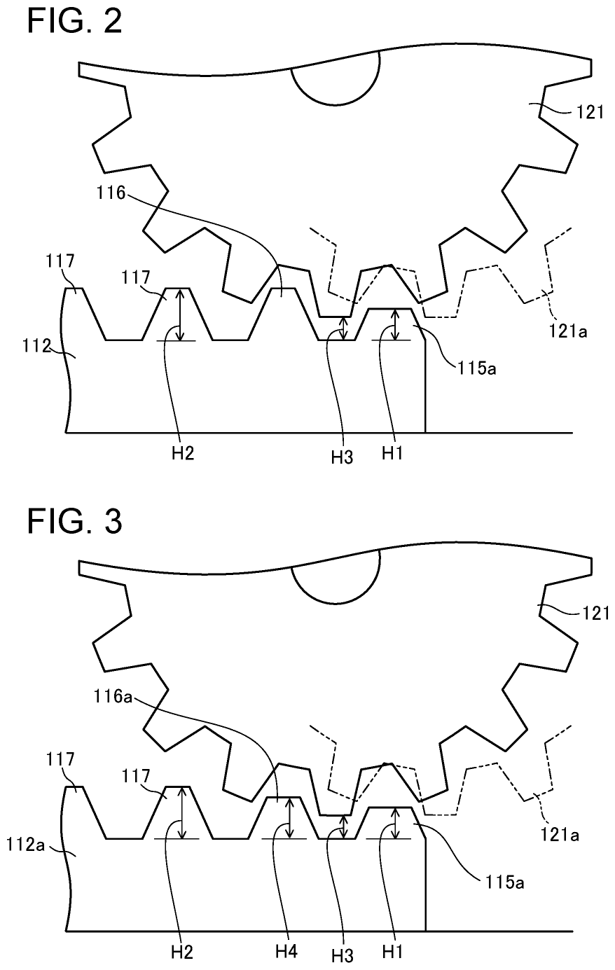

Referring to FIGS. 2 to 7, variants of a specific shape of the end tooth 115 are described. In FIG. 2, the end tooth is labeled with a reference sign 115a. As described above, the adjacent tooth 116 has the same shape as that of the normal teeth 117. In FIGS. 2 to 7, the depiction of the floor panel 111, the body 129 of the pinion unit 120, and the rollers 128 is omitted. A pinion gear 121a depicted by an imaginary line represents the pinion gear 121 which is about to engage the gear rack 112 from the right.

In the variant of FIG. 2, in the side view of the gear rack 112, the size of an end tooth 115a is smaller than the size of normal teeth 117. In the example of FIG. 2, an adjacent tooth 116 has the same size as that of the normal teeth 117. That is, all the teeth other than the end tooth 115a are normal teeth 117.

A height H1 of the end tooth 115a is lower than a height H2 of the normal teeth 117. The height H1 of the end tooth 115a is larger than a distance H3 between the bottom of a tooth of the gear rack 112 and a tip of a tooth of the pinion gear 121 that is in engagement with the gear rack 112. Since the end tooth 115a has a smaller size (lower height), a larger space is created between the pinion gear 121 and the end tooth 115a than a space between the pinion gear 121 and the normal teeth 117. This allows the pinion gear 121 to easily engage the end tooth 115a when it reaches the end of the gear rack 112 after moving along the free section. The condition “height H1>distance H3” is required for the pinion gear 121 to engage the end tooth 115a.

FIG. 3 shows a first variant (a gear rack 112a) of the gear rack. In the variant of FIG. 3, in the side view of the gear rack 112a, the size of the end tooth 115a is smaller than the size of the normal teeth 117, and the size of the adjacent tooth 116a is larger than the size of the end tooth 115a and smaller than the size of the normal teeth 117. The height H1 of the end tooth 115a is larger than the distance H3 between the bottom of a tooth of the gear rack 112a and a tip of a tooth of the pinion gear 121 that is in engagement with the gear rack 112a. A height H4 of the adjacent tooth 116a is higher than the height H1 of the end tooth 115a and lower than the height H2 of the normal teeth 117. The gradually decreasing heights of the teeth from the center toward the end of the gear rack 112a allows the pinion gear 121 to easily engage the gear rack 112a when it reaches the end of the gear rack 112a.

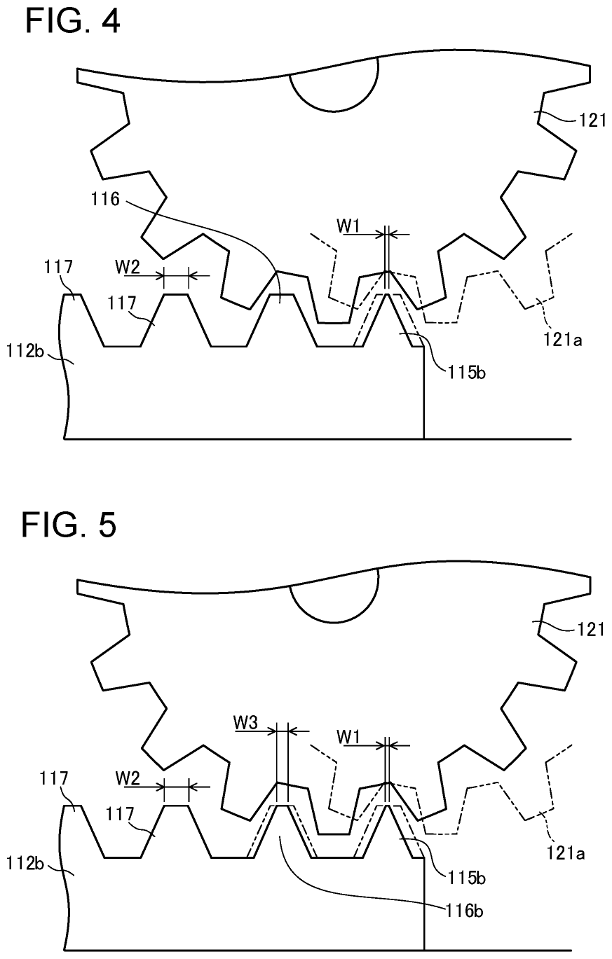

FIG. 4 shows a second variant of gear rack (gear rack 112b). The pinion gear 121a depicted by the imaginary line represents the pinion gear 121 which is about to engage an end tooth 115b. In the variant of FIG. 4, in the longitudinal direction, a tip width W1 of the end tooth 115b is narrower than a tip width W2 of normal teeth 117, i.e., tip width W1<tip width W2. In FIG. 4, a normal tooth is depicted by an imaginary line over the end tooth 115b in order to aid understanding. In the example of FIG. 4, the adjacent tooth 116 has the same shape as that of the normal teeth 117.

In the variant of FIG. 4 as well, a space between the pinion gear 121 and the end tooth 115b is larger than the normal space (space between the pinion gear 121 and a normal tooth 117 created when the pinion gear 121 engages the normal tooth 117). The narrower tip width W1 of the end tooth 115b also allows the pinion gear 121 to easily engage the end tooth 115b when it reaches the gear rack 112b.

In the variant of FIG. 5, in the longitudinal direction, the tip width W1 of the end tooth 115b is narrower than the tip width W2 of the normal teeth 117, i.e., tip width W1<tip width W2. Further, a tip width W3 of an adjacent tooth 116b is larger than the tip width W1 and narrower than the tip width W2, i.e., W1<W3<W2. The gradually narrowing tip widths of the teeth from the center toward end of the gear rack 112b allows the pinion gear 121 to more smoothly engage the gear rack 112b when it reaches the gear rack 112b.

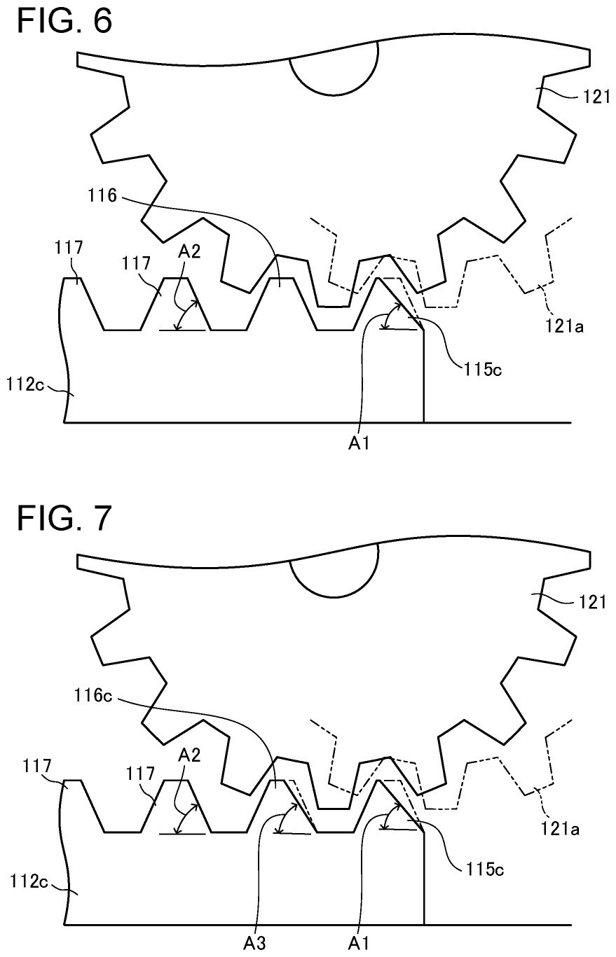

In the variant of FIG. 6, in the side view, an angle A1 of a side surface of an end tooth 115c that is located closer to the end of gear rack is smaller than an angle A2 of side surfaces of normal teeth 117, i.e., angle A1<angle A2. Here, “the angle A1(A2) of a side surface(s)” means an angle of the side surface relative to the longitudinal direction of a gear rack 112c.

In the variant of FIG. 6, an adjacent tooth 116 has the same shape as that of the normal teeth 117. Since the angle A1 of the side surface of the end tooth 115c is smaller than the angle A2, a space between the pinion gear 121 and the end tooth 115c is larger than the normal space (space between the pinion gear 121 and a normal tooth 117 created when the pinion gear 121 engages the normal tooth 117). The smaller angle A1 of the side surface of the end tooth 115c also allows the pinion gear 121 to easily engage the end tooth 115c when it reaches the gear rack 112c.

In the variant of FIG. 7, in the side view, the angle A1 of the side surface of the end tooth 115c that is located closer to the end of the gear rack is smaller than the angle A2 of side surfaces of the normal teeth 117. An angle A3 of a side surface of an adjacent tooth 116c that is located closer to the end of the gear rack is larger than the angle A1 and smaller than the angle A2, i.e., angle A2>angle A3>angle A1. The gradually decreasing side surface angles of the teeth from the center toward end of the gear rack 112c allows the pinion gear 121 to more smoothly engage the gear rack 112c when it reaches the end of the gar rack 112c.

The height of the end tooth may be lower than the height of the normal teeth and the tip width of the end tooth may be narrower than the tip width of the normal teeth. The height of the end tooth may be lower than the height of the normal teeth and the angle of the side surface of the end tooth may be smaller than the angle of side surfaces of the normal teeth. The tip width of the end tooth may be narrower than the tip width of the normal teeth and the angle of the side surface of the end tooth may be smaller than the angle of side surfaces of the normal teeth. The height of the end tooth may be lower than the height of the normal teeth, the angle of the side surface of the end tooth may be smaller than the angle of side surfaces of the normal teeth, and the tip width of the end tooth may be narrower than the tip width of the normal teeth.

In each of the gear rack according to the embodiment and the gear racks according to the variants, the size of the end tooth is smaller, so that the pinion gear, which approaches the gear rack along the longitudinal direction, can smoothly engage the gear rack.

The technology disclosed herein may be embodied as a rack-and-pinion system including a gear rack and a pinion gear configured to engage the gear rack. The pinion gear is provided on a pinion unit, and the pinion unit is movable in a longitudinal direction of the gear rack but is restricted to move in planes orthogonal to the longitudinal direction. The pinion unit approaches the gear rack along the longitudinal direction, and the pinion gear engages the gear rack. The size of an end tooth is smaller than that of normal teeth, and thus a large space is created between the end tooth and the pinion gear when the pinion gear reaches the end tooth of the gear rack. Specifically, this space is larger than a space created between the pinion gear and a normal tooth when the pinion gear engages the normal tooth. Thus, the pinion gear can smoothly engage the end tooth. This rack-and-pinion system allows the pinion gear (the pinion unit), which approaches the gear rack along the longitudinal direction, to smoothly engage the gear rack. Examples of the specific shape of the end tooth were shown in FIGS. 2 to 7.

Next, an embodiment in which a gear rack according to the technology disclosed herein is applied to a linear actuator is described.

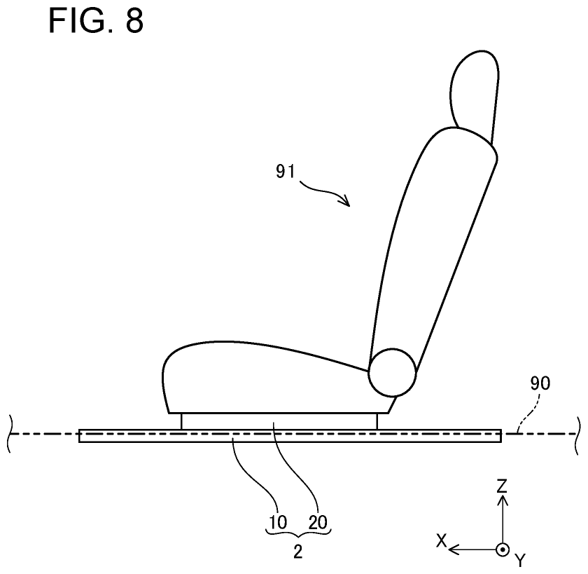

The linear actuator according to an embodiment is a seat slider device 2 disposed between a floor panel and a seat. FIG. 8 shows a side view of the seat slider device 2 attached to a floor panel 90 of a vehicle. The seat slider device 2 comprises a lower rail 10 and an upper rail 20. The lower rail 10 is elongated. The upper rail 20 is attached to the lower rail 10 such that the upper rail 10 is movable (slidable) with respect to the lower rail 10 in its longitudinal direction. The upper rail 20 can be moved by a motor along the lower rail 10, which will be described in detail later. When a user turns on a switch (not shown), the motor starts rotating and the upper rail 20 (the seat) is moved along the lower rail 10. The lower rail 10 corresponds to a rail of the linear actuator and the upper rail 20 corresponds to a pinion unit of the linear actuator.

The lower rail 10 is fixed to the floor panel 90 of a vehicle body. The upper rail 20 is attached to a lower portion of a seat 91. The upper rail 20 is attached to the lower portion of the seat 91 via a frame (not shown). A pair of seat slider devices 2 is attached to the single seat 91. The upper rails 20 are attached to left and right sides of the lower portion of the seat 91, respectively. The lower rails 10 are fixed to the floor panel 90 to correspond to the upper rails 20, respectively.

An X direction in the directional indicator in the drawings corresponds to a longitudinal direction of the lower rail 10 and the upper rail 20. The longitudinal direction of the rails (X direction) will be hereinafter referred to as a rail longitudinal direction. A Y direction in the directional indicator in the drawings corresponds to a short direction of the rails. The short direction of the rails will be hereinafter referred to as a rail short direction. A+Z direction in the directional indicator in the drawings indicates an upward direction.

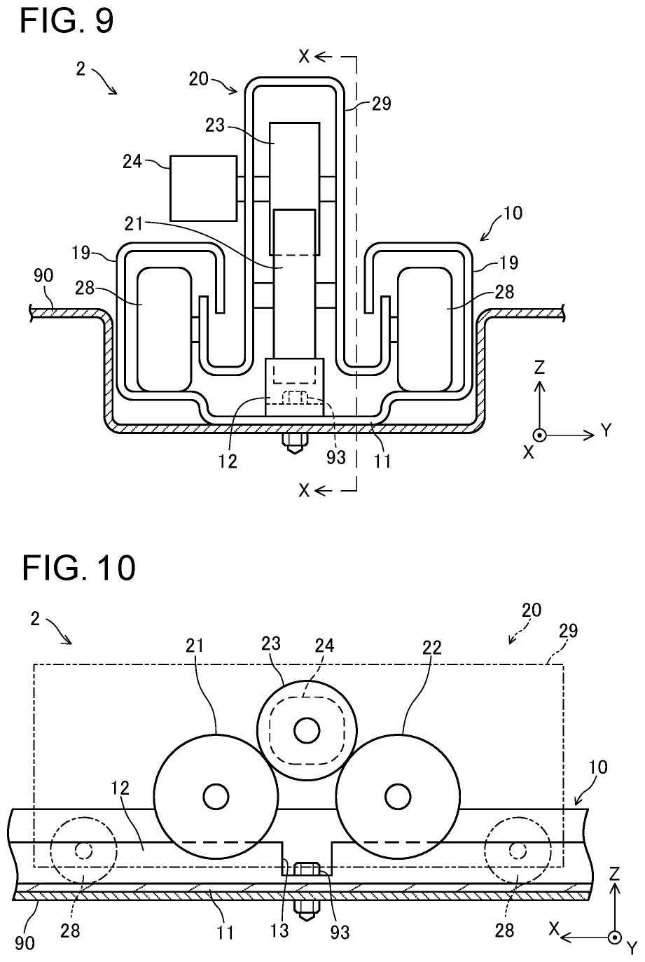

FIG. 9 shows a front view of the seat slider device 2. FIG. 9 shows the seat slider device 2 as viewed in the rail longitudinal direction. FIG. 10 shows a side view of the seat slider device 2. FIG. 10 shows a side view of the seat slider device 2 along a line X-X in FIG. 9.

The lower rail 10 has a channel-like cross sectional shape when cut along a plane orthogonal to the rail longitudinal direction. The lower rail 10 includes a bottom plate 11 and a pair of side plates 19 extending upward from both ends of the bottom plate 11 in the rail short direction. The lower rail 10 further includes a gear rack 12 extending along the rail longitudinal direction. The gear rack 12 is fixed to the bottom plate 11. In FIGS. 9 and 10, the depiction of gear teeth of the gear rack 12 is omitted.

A groove is defined in the floor panel 90 and the lower rail 10 is disposed in the groove of the floor panel 90. The lower rail 10 is fixed to the floor panel 90 with bolts. Hereinafter, the EMBODIMENT focuses on one bolt (a bolt 93). The head of the bolt 93 is disposed among a row of teeth of the gear rack 12 in the rail longitudinal direction. A notch 13, which is open upward, is defined in the gear rack 12 and the head of the bolt 93 is placed in the notch 13. The bolt 93 fastens the gear rack 12, the bottom plate 11, and the floor panel 90 together.

The upper rail 20 includes a plurality of rollers 28. The rollers 28 are located at four corners of a body 29 of the upper rail 20. The rollers 28 are in contact with the bottom plate 11 of the lower rail 10. The four rollers 28 allow the upper rail 20 to smoothly move along the lower rail 10. Upper portions of the side plates 19 of the lower rail 10 are curved in inverted U-shape and the rollers 28 are accommodated in spaces defined by the bottom plate 11 and the upper curved portions of the side plates 19. In FIG. 10, the body 29 of the upper rail 20 and the rollers 28 are depicted with imaginary lines.

The upper rail 20 includes two pinion gears (a first pinion gear 21 and a second pinion gear 22), one idle gear 23, and a motor 24. In FIGS. 9 and 10, the first pinion gear 21, the second pinion gear 22, and the idle gear 23 are depicted in a simplified manner and the depiction of gear teeth is omitted. The first pinion gear 21 and the second pinion gear 22 engage the gear rack 12, and the idle gear 23 engages both the first pinion gear 21 and the second pinion gear 22. The motor 24 drives the idle gear 23 via a speed reducer (not shown). As the motor 24 drives the idle gear 23, the first pinion gear 21 and the second pinion gear 22 rotate in a synchronized manner in conjunction with the idle gear 23. When the first pinion gear 21 and the second pinion gear 22 are driven by the motor 24, the upper rail 20 is moved along the gear rack 12. That is, the upper rail 20 is moved on the lower rail 10 in an electrically powered manner.

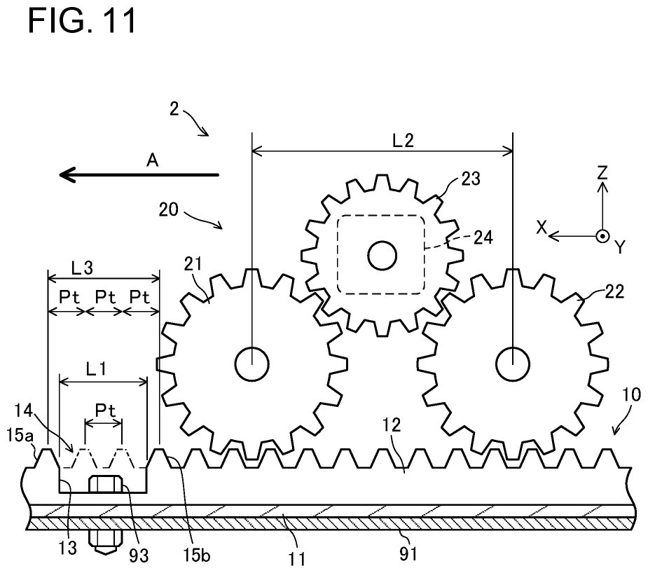

Referring to FIGS. 11 to 14, how the gears engage each other is described. In FIGS. 11 to 14, the depiction of the body 29 of the upper rail 20 and the rollers 28 is omitted. The depiction of the side plates 19 of the lower rail 10 is also omitted. In FIGS. 11 to 14, there are gaps between the engaging gears but these gaps are provided only for convenience sake in order to facilitate understanding of the drawings. Naturally, backlash between two engaging gears should be as little as possible.

As described above, the notch 13 which is open upward is defined in the gear rack 12. There are no teeth in the range of the notch 13. The range of the notch 13 (i.e., the range without teeth) will be hereinafter referred to as a no-teeth section 14. The no-teeth section 14 is located among the row of teeth of the gear rack 12. The head of the bolt 93 is placed in the no-teeth section 14. The bolt 93 penetrates the bottom of the notch 13, the bottom plate 11 of the lower rail 10, and the floor panel 90 and fixes them together.

The no-teeth section 14 is provided in order to secure a space for placing the head of the bolt 93 on the narrow bottom plate 11. The no-teeth section 14 has a length L1 in the rail longitudinal direction. The length L1 is equal to or longer than two pitches of the teeth of the gear rack 12. In FIGS. 11 to 14, the gear teeth are depicted by an imaginary line also within the no-teeth section 14 to facilitate understanding of the relationship between the length L1 and tooth pitch. The reference sign Pt in FIG. 11 indicates a tooth pitch. In the present embodiment, the length L1 of the no-teeth section 14 is longer than twice the teeth pitch Pt and shorter than three times the teeth pitch Pt.

The two pinion gears (the first pinion gear 21 and the second pinion gear 22) are attached to the upper rail 20. The two pinion gears are arranged along the rail longitudinal direction. The two pinion gears are spaced apart from each other by a center-to-center distance L2 along the rail longitudinal direction. The two pinion gears (the first pinion gear 21 and the second pinion gear 22) have the same shape. The two pinion gears (the first pinion gear 21 and the second pinion gear 22) have the same diameter and the same number of teeth. As described above, the idle gear 23 engages both the first pinion gear 21 and the second pinion gear 22, and the motor 24 drives the first pinion gear 21 and the second pinion gear 22 via the idle gear 23. Since the first pinion gear 21 and the second pinion gear 22, which have the same shape, rotate in a synchronized manner via the single idle gear 23, they smoothly rotate while engaging the gear rack 12.

In FIGS. 11 to 14, it is assumed that the upper rail 20 moves in a direction indicated by a bold arrow A (leftward). However, for the sake of expedience, the lower rail 10 is depicted as if it gradually moves from the left to right, from FIG. 11 through FIG. 14, and thus the no-teeth section 14 is depicted as if it gradually moves from the left to right, from FIG. 11 through FIG. 14.

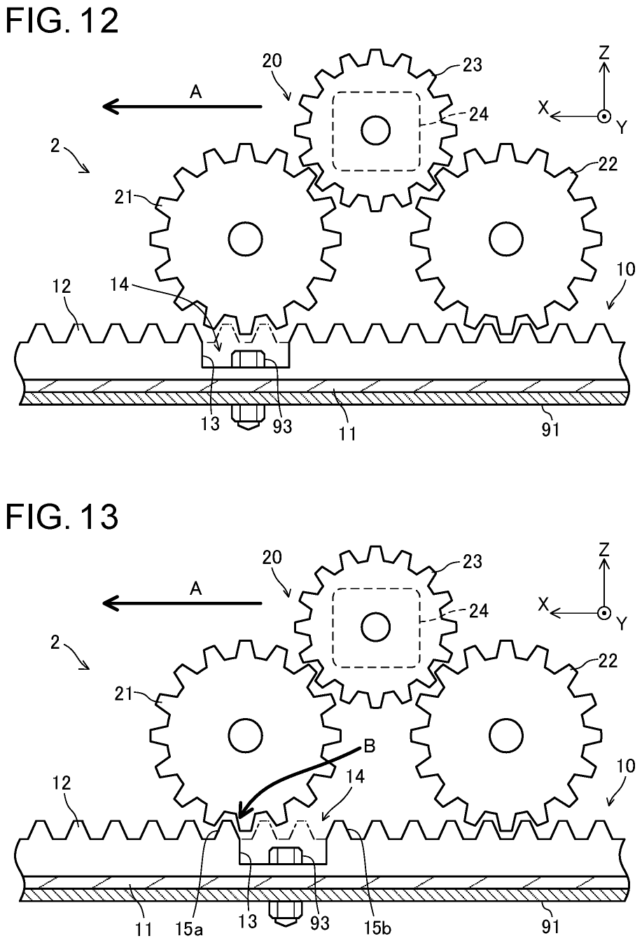

In FIG. 11, the no-teeth section 14 is located forward of the upper rail 20 in its direction of movement. The length L1 of the no-teeth section 14 is equal to or longer than two teeth pitches Pt of the gear rack 12. Therefore, when the first pinion gear 21 reaches the no-teeth section 14, the first pinion gear 21 disengages from the gear rack 12 and spins freely (FIG. 12). However, the upper rail 20 can keep moving because the second pinion gear 22 is in engagement with the gear rack 12.

As the upper rail 20 moves further, the first pinion gear 21 reengages the gear rack 12 (FIG. 13). A distance L3 between two end teeth 15a, 15b located on both sides of the no-teeth section 14 is an integral multiple of the teeth pitch Pt. As shown in FIG. 11, in the present embodiment, the distance L3 is three times the teeth pitch Pt. The distance L3 between the two end teeth 15a, 15b means a distance from the center of one end tooth 15a to the center of the other end tooth 15b. Thus, after passing the no-teeth section 14 while spinning freely, the first pinion gear 21 can smoothly reengage the gear rack 12. The site pointed by a bold arrow B in FIG. 13 indicates the reengagement point of the end tooth 15a and the first pinion gear 21. Although the first pinion gear 21 spins freely while passing the no-teeth section 14, the end tooth 15a fits in a tooth groove of the first pinion gear 21 when the first pinion gear 21 reengages the gear rack 12.

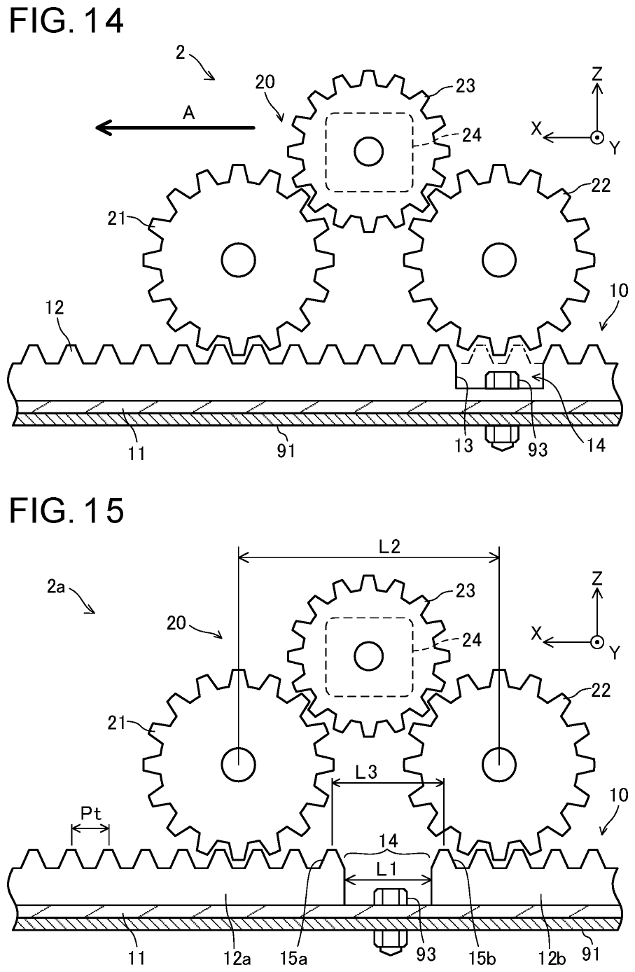

As the upper rail 20 moves further leftward, the second pinion gear 22 passes the no-teeth section 14 (FIG. 14). At this time, the second pinion gear 22 spins freely, however, the upper rail 20 can keep moving forward because the first pinion gear 21 is in engagement with the gear rack 12. As with the case of the first pinion gear 21, the second pinion gear 22 can also smoothly reengage the gear rack 12.

As described above, in the seat slider device 2 according to the embodiment, the bolt 93 can be placed among the row of teeth of the gear rack 12 since the no-teeth section 14 is provided in the gear rack 12. The upper rail 20 including the two pinion gears (the first pinion gear 21 and the second pinion gear 22) can smoothly move across the no-teeth section 14. The length L1 of the no-teeth section 14 is shorter than the center-to-center distance L2 of the two pinion gears (the first pinion gear 21 and the second pinion gear 22). This is because the both pinion gears enter the no-teeth section if the no-teeth section 14 is longer than the center-to-center distance L2. The distance L3 between the two end teeth 15a, 15b may be shorter than the center-to-center distance L2. Another component than a bolt may be placed in the no-teeth section 14.

Referring to FIG. 15, a seat slider device 2a according to a variant is described. An upper rail 20 of the seat slider device 2a is the same as the upper rail 20 of the seat slider device 2 according to the embodiment. The depiction of the body of the upper rail 20 and rollers is omitted in FIG. 15. The seat slider device 2a according to the variant includes two gear racks 12a, 12b. The two gear racks 12a, 12b are spaced apart from each other by a length L1 in the rail longitudinal direction. The space of the length L1 between the two gear racks 12a, 12b corresponds to a no-teeth section 14. The head of a bolt 93 is placed in the no-teeth section 14. The length L1 is equal to or longer than two pitches of teeth of the gear racks and shorter than a center-to-center distance L2 of two pinion gears. Further, a distance L3 between end teeth 15a, 15b located on both sides of the no-teeth section 14 is equal to an integral multiple of a pitch of teeth of the gear racks 12a, 12b. The distance L3 is shorter than the center-to-center distance L2.

The seat slider device 2a is also moved by the motor 24 in an electrically powered manner. In the seat slider device 2a as well, the upper rail 20 can smoothly move across the no-teeth section 14.

The upper rail 20 (pinion unit) includes the motor 24 configured to drive the pinion gears 21, 22. The disclosure herein provides a gear rack that allows a pinion gear, which does not yet engage the gear rack, to smoothly engage the gear rack. The pinion unit may not include a motor because it is conceivable that the pinion unit is manually moved by a user. Even without a motor, the pinion unit including two cooperating pinion gears engages an end tooth of the gear rack while the pinion gears are rotating. As shown in the example of FIG. 15, it is assumed that the pinion unit moves leftward while the second pinion gear 22 engages a gear rack 12b. The first pinion gear 21 rotates even in the no-teeth section since it cooperates with the second pinion gear 22 moving on the gear rack 12b. The first pinion gear 21 reaches a gear rack 12a while rotating. In this case, owing to the function of a small end tooth 15a, the rotating first pinion gear 21 can smoothly engage the end tooth 15a.

The gear racks 12, 12a, 12b of the seat slider devices 2, 2a may include the end teeth (and the adjacent teeth) shown in FIGS. 2 to 7.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A gear rack, wherein a size of an end tooth located at an end of a row of teeth on the gear rack is smaller than a size of normal teeth located closer to a center of the row of teeth than the end tooth.

2. The gear rack of claim 1, wherein a size of an adjacent tooth located adjacent to the end tooth is larger than the size of the end tooth and smaller than the size of the normal teeth.

3. The gear rack of claim 1, wherein
a height of the end tooth is lower than a height of the normal teeth, and
the height of the end tooth is greater than a distance between a bottom of the normal teeth and a tip of a tooth of a pinion gear when the pinion gear engages the gear rack.

4. The gear rack of claim 3, wherein a height of an adjacent tooth located adjacent to the end tooth is higher than the height of the end tooth and lower than the height of the normal teeth.

5. The gear rack of claim 1, wherein in a longitudinal direction of the gear rack, a tip width of the end tooth is narrower than a tip width of the normal teeth.

6. The gear rack of claim 5, wherein in the longitudinal direction, a tip width of an adjacent tooth located adjacent to the end tooth is wider than the tip width of the end tooth and narrower than the tip width of the normal teeth.

7. The gear rack of claim 1, wherein an inclination angle of a side surface of the end tooth that is located closer to an end of the gear rack is smaller than an inclination angle of side surfaces of the normal teeth.

8. The gear rack of claim 7, wherein
the row of teeth includes an adjacent tooth located adjacent to the end tooth, and
an inclination angle of a side surface of the adjacent tooth that is located closer to the end of the gear rack is larger than the inclination angle of the side surface of the end tooth and smaller than the inclination angle of the side surfaces of the normal teeth.
